(19) United States
(12) Patent Application Publication
(10) Pub. No.: US 2008/0134140 A1
(43) Pub. Date: Jun. 5, 2008

(54) INTEGRATED DRUG DEVELOPMENT SOFTWARE PLATFORM

(75) Inventors: Daniel L. Weiner, Apex, NC (US); Michael Robert Dunlavey, Needham, MA (US); Daniel Xavier Gilroy, Durham, NC (US); Robert Hemstreet Leary, Cary, NC (US); Jason Todd Chittenden, Raleigh, NC (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Pharsight Corporation, Mountain View, CA (US)

(21) Appl. No.: 11/872,369

(22) Filed: Oct. 15, 2007

Related U.S. Application Data
(60) Provisional application No. 60/852,374, filed on Oct. 16, 2006.

(51) Int. Cl. G06F 9/44

(52) U.S. Cl. 717/105

(57) ABSTRACT

Embodiments in accordance with the present invention relate to a platform facilitating different drug development software programs. In one embodiment, the integrated software platform includes a graphical environment for creating, storing, and manipulating workflows. The workflows depict operations that are to be performed by certain functional objects, and the flow of information between those objects. One example of an object is a model of drug behavior, disposition, and/or physiological response to drug activity, and certain embodiments allow for the graphical creation and editing of such a model. Other embodiments provide a user with the ability to easily overlay model predicted valves with observed data.

### CROSS-REFERENCE TO RELATED APPLICATION

The instant nonprovisional patent application claims priority to U.S. Provisional Patent Application No. 60/852,374, filed Oct. 16, 2006 and incorporated by reference in its entirety herein for all purposes.

### BACKGROUND OF THE INVENTION

The process of drug development calls upon a variety of skills in many different disciplines. FIG. 1 shows a simplified schematic diagram illustrating the various fields typically involved in the process of developing a new pharmaceutical entity.

In the realm of drug formulation 102, a dosage form is developed for a potentially active pharmaceutical agent, to optimize the delivery of the agent to the physiological site of action. Other considerations given during this process include: patients' adherence to a treatment regimen; stability (or shelf-life) of the formulation; ease of administration (dispensation); cost of manufacturing; and quality control. A potentially active pharmaceutical agent is identified through the process of drug development. This may involve screening and analysis of potentially active compounds utilizing computer simulations and modeling. Data collected and/or used for these efforts includes, but is not limited to: solubility; membrane permeability; lipophilicity; dissolution rate; and degradation rate.

In the pre-clinical realm 104, professionals such as toxicologists, kineticists, pharmacologists, and biochemists work together to identify therapeutic criteria such as. This pre-clinical stage of drug development also involves the extensive manipulation and analysis of data in electronic form by a computer.

Finally, in the clinical stage 106 of drug development, pharmacokinetic (PK) studies of the effect of the drug in a target population are performed. Such clinical studies involve the analysis and manipulation of large quantities of data, particularly where the target population for the clinical study is large, and where many different data points are sampled.

Certain techniques may be employed in more than one stage of the drug development process. For example, In-Vito/In-Vivo correlation (IV/IVC) comprise a set of techniques useful to extrapolate the behavior of a drug candidate from the laboratory (In Vitro), to its activity within a biological system (In Vivo). IV/IVC is commonly employed in both the drug formulation 102 and clinical 106 stages of drug development efforts. IV/IVC techniques are highly computationally intensive and require rapid and complex mathematical manipulation of large data sets.

As another example, the Drug Metabolism Pharmacokinetics (DMPK) department of a pharmaceutical company is responsible for taking biological samples (such as blood plasma) and analyzing them for drug content. DMPK is important for monitoring the rate at which an organism is able to receive, absorb, and then eliminate a drug from its system. DMPK is frequently employed in both the pre-clinical 104 and clinical 106 stages of drug development. DMPK is also highly computationally intensive, and requires rapid and complex mathematical manipulation of large data sets.

In view of the above, there is a need in the art for a computer-based electronic platform which facilitates coordination of the collection, manipulation, analysis, and sharing of drug development data between the various professionals involved in the different realms of the drug development process.

### BRIEF SUMMARY OF THE INVENTION

Embodiments in accordance with the present invention relate to a platform supporting different drug development software programs. In one embodiment, the integrated software platform includes a graphical environment for creating and editing models of drug behavior, disposition, and/or physiological response to drug activity. Other embodiments provide a user with the ability to easily overlay and thus compare/contrast model-predicted valves with observed data. Still other embodiments provide interactive workflow diagrams displaying an overview of tasks to be completed by functional objects supported by the platform, as well as a simple way of navigating to the input settings for each task. These tasks include, but are not limited to, data manipulations, mathematical modeling, graphics generation, report preparation, and integration with third party software.

An embodiment of a system for drug modeling and simulation according to the present invention, comprises a processor and a computer-readable storage medium having code stored thereon. The code is configured to instruct the processor to display a graphical workflow comprising an object and a flow of information to and from the object, apply the workflow to a data set, display a progress of completion of the operation by the workflow, and update the workflow to reflect a changed attribute of the object or an application of the workflow to a different data set.

An embodiment of a method in accordance with the present invention, comprises, causing a display of a graphical workflow to a user, the workflow comprising an object and a flow of information to and from the object. A result of application of the workflow to a data set is displayed, and the user is allowed to change an attribute of the object or the data set, utilizing the graphical workflow. The display of the workflow is updated to reflect the changed attribute or the changed data set.

An embodiment of a system according to the present invention to perform modeling and simulation of data for drug development, comprises, a services architecture configured to display a workflow comprising a plurality of objects connected by lines to depict a flow of information between the objects, the services architecture further configured to communicate with a plug-in through a service management layer, the plug-in providing a functionality selected from data manipulation, modeling, graphics creation, report generation, data analysis, and third party tool integration.

An embodiment of a computer software plug-in program in accordance with the present invention, comprises, a computer-readable storage medium having stored thereon code configured to instruct a processor to, depict a mathematical model as a graphical representation; edit the mathematical model utilizing the graphical representation; apply the mathematical model to a data set to produce a result; and serve as an interface to communicate the graphical representation and the result through a service management layer to a services architecture responsible for displaying the graphical representation and the result to a user.

A further understanding of the aspects of various embodiments in accordance with the present invention can be made by way of reference to the ensuing detailed description taken in conjunction with the accompanying drawings.

### BRIEF DESCRIPTION OF THE DRAWINGS

FIG. 1 shows a simplified schematic diagram illustrating the various fields typically involved in the process of developing a new pharmaceutical entity.

FIG. 2 shows a simplified back diagram of an infrastructure that is being proposed by the United States Federal Food and Drug Administration (FDA).

FIG. 3 shows a simplified schematic diagram illustrating the role played by an integrated software platform in accordance with an embodiment of the present invention.

FIG. 4 shows the spectrum of PK-PD techniques that are typically employed.

FIG. 5 shows a simplified schematic diagram of architecture of the Phoenix drug development platform job management system in accordance with an embodiment of the present invention.

FIG. 6 is a simplified schematic diagram showing interaction between the Phoenix software platform and various plug-in modules such as NLME, LinMix, NCA, and others.

FIG. 6A is a simplified schematic diagram showing interaction between a modeling plug-in module and the Phoenix software platform.

FIGS. 7A-M show screenshots of different elements of a graphic user interface (GUI) of an embodiment of the Phoenix drug development software platform.

FIG. 8 is a schematic illustration of a computer system for use in accordance with embodiments of the present invention.

FIG. 8A is an illustration of basic subsystems the computer system of FIG. 8.

FIG. 9 is a more detailed depiction of a graphical depiction of a model of a workflow.

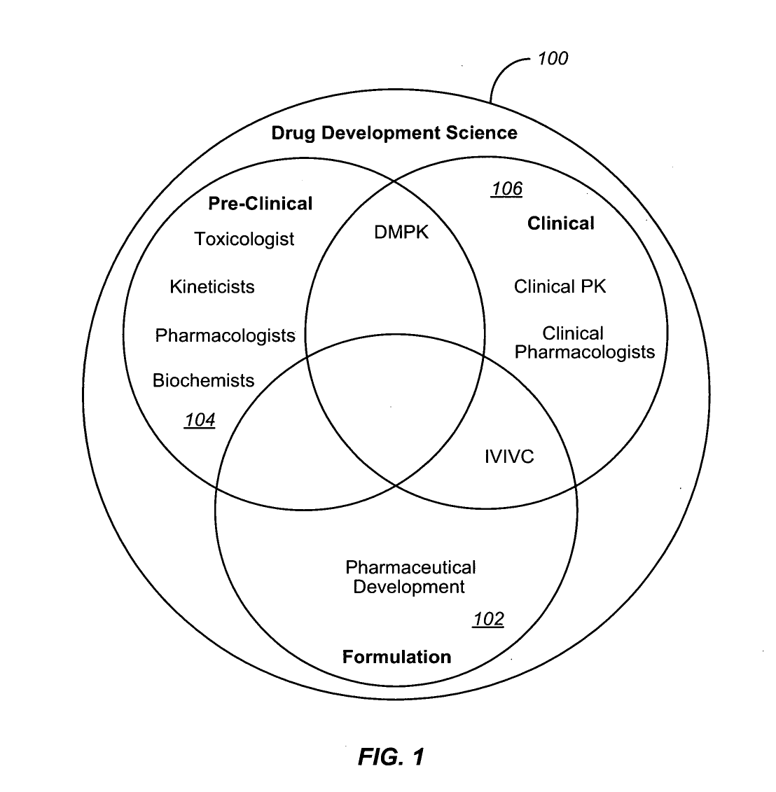

### DETAILED DESCRIPTION OF THE INVENTION

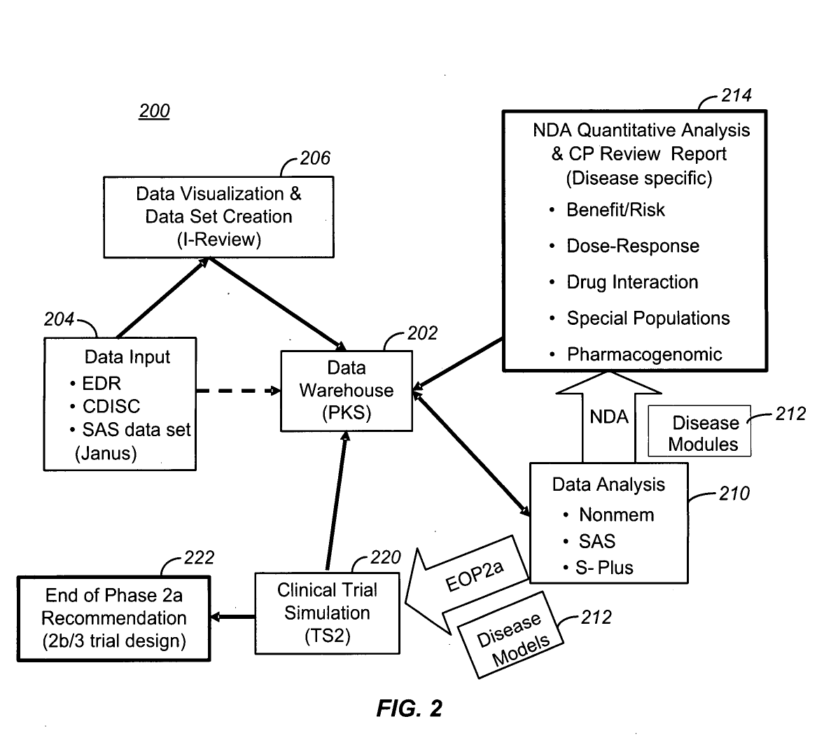

FIG. 2 shows a simplified back diagram of an infrastructure that is being proposed by the United States Federal Food and Drug Administration (FDA) to streamline the process of regulatory approval for pharmaceutical entities. Central to scheme 200 for FIG. 2 is the PKS data warehouse 202, which is essentially a database storing different types of data that allows the FDA to determine the efficacy and safety of a pharmaceutical entity. Examples of such data include but are not limited to clinical trial data, and pre-clinical trial data such as toxicokinetic data/The PKS data warehouse allows data storage and retrieval in compliance with 21 CFR § 11, which stipulates the conditions under which data used for regulatory submission is stored and controlled.

Data in the PKS data warehouse 202 may be compiled from a number of different services utilizing different techniques and tools. For example, as shown in block 204, data may be input directly into the PKS data warehouse from an electronic data repository (EDR). In addition, the Clinical Data Interchange Standards Consortium (CDISC) (http://www.cdisc.org) has established standard formats for drug development data across different domains, and disciplines. Other software packages such as the Janus software program or SAS are already widely used to store drug development data.

Alternatively, as illustrated in block 206 of FIG. 2, data may be input indirectly into the PKS data warehouse. Such indirect data input approaches utilize techniques such as data visualization and data set creation. For example, certain custom software code (data connectors) can be developed to transport data from systems outside of PKS into PKS. Such connectors can add functionality over and above the mere importation of data. Examples of such enhanced functionality include but are not limited to the implementation of business rules, the creation and transformation of variables, and the communication of email notifications that such a data transfer has taken place.

As shown in FIG. 2, the schemes of compiled data stored in PKS 202 can be analyzed utilizing a variety of different tools, to further the process of regulatory approval. For example, data analysis engine 210 may access data from PKS warehouse 202 to model a particular disease (disease modules 212). Examples of tools useful for the analysis of drug development data include but are not limited to Non-Linear Mixed Effect Modeling (NONMEM) developed by the University of California at San Francisco (UCSF) and marketed by GloboMax LLC (http://c255.ucsfedu/nonmeml.html), software developed by the SAS Institute, Inc. of Cary, N.C. (http://www.sas.com), and the S-Plus math software package available form Insightful Corporation of Seattle, Wash. (http://www.insightful.com/industry/pharm/default.asp).

One or more data analysis tools, including models of drug behavior, disposition, and physiological response to a drug, may be applied to the data stored in the PKS to achieve different regulatory goals. One such goal is in the pursuit of a New Drug Application (NDA). As shown in box 214, analysis of data stored in the PKS can be utilized as part of an NDA submitted to the FDA. These results of drug analysis may reveal the benefits and risks of the proposed new drug, and also the correlation between dose (or exposure) and patient response. The results of data analysis in connection with an NDA may also reveal important information regarding drug interactions, the effect of the drug in patient populations having special characteristics, and the influence of a patient's genetic profile on drug efficacy and safety (pharmacogenomics).

Data stored in the PKS data warehouse may also be analyzed in connection with an EOP2a meeting. For this application, as shown in block 220, analyzed data from warehouse 202 may be used to simulate a clinical trial. Resulting data from the simulated clinical trial may be sent to the data warehouse. At the EOP2a meeting, the FDA and drug candidate sponsor will discuss a proposed design for subsequent phase 2b studies. The choice of the particular design will be supported by computer-assisted trial design, in part utilizing inputs from the PKS.

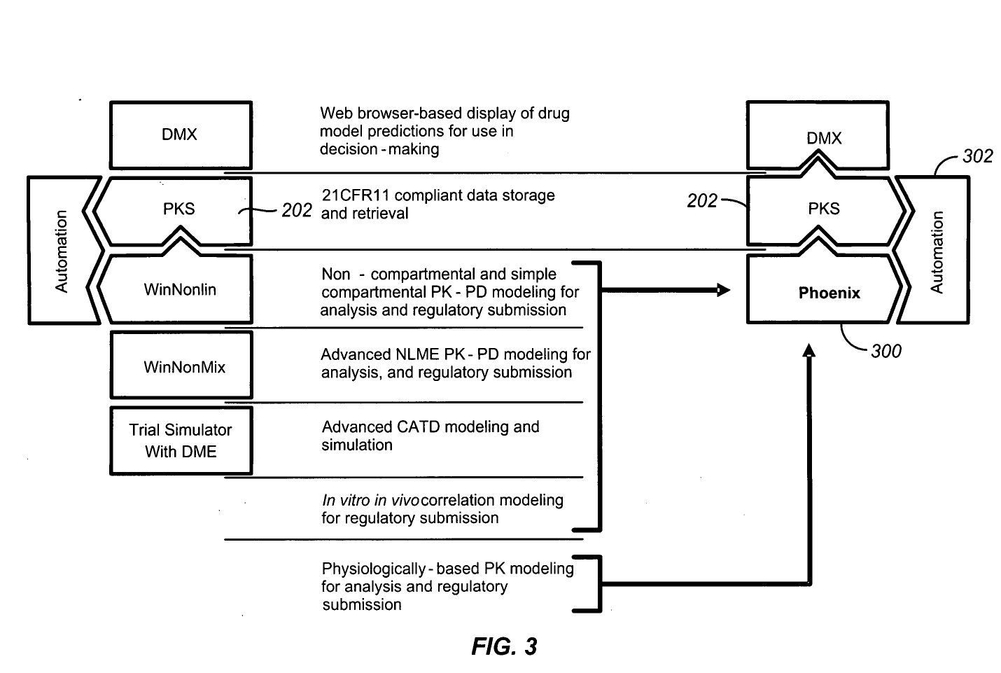

FIG. 3 shows a simplified schematic diagram illustrating the role played by an integrated software platform in accordance with an embodiment of the present invention hereafter (“Phoenix”). As shown in FIG. 3, the Phoenix software platform 300 is designed to integrate with the PKS data warehouse 202. The Phoenix software platform 300 is also designed to integrate with automation software 302 which orchestrates the interaction between the Phoenix platform and (potentially) PKS to execute multiple and large data analysis and reporting workflows.

In accordance with certain embodiments, the Phoenix drug development software platform will be designed to facilitate non-compartmental and compartmental PK-PD modeling for analysis and regulatory submission. The Phoenix platform may also be used for Advanced Non-Linear mixed Effect (NLME) pharmacokinetic-pharmacodynamic (PK-PD) modeling for analysis, and regulatory submission. The Phoenix platform may also be used for advanced computer-assisted trial simulation (CATD) modeling.

Other embodiments of the Phoenix drug development software platform facilitate physiologically-based PK (PB-PK) modeling for analysis and regulatory submission. Analytical techniques supported by the Phoenix software platform include physiologically based pharmacokinetic PB/PK (and pharmacodynamic—PD) models for interspecies scaling—both empirical and mechanistic. The Phoenix drug development software platform of the present invention may also include a built-in library of models and datasets containing physiological parameters (such as organ weights, blood flows, tissue compositions etc.) for commonly tested species such as mice, humans, rates, dogs, or apes. The Phoenix software platform may also include the variability of said physiological parameters both within and between species, as well as relationships between these parameters and other species specific data such as measures of size, weight, and age of individuals. In addition, the Phoenix software platform may contain datasets that describe the statistical distribution of said parameters and measures in the populations or the aforementioned species.

Use of various embodiments of the Phoenix drug development platform in accordance with embodiments of the present invention may offer certain benefits. For example, the Phoenix drug development platform may offer one collaborative platform for all drug development scientists. Examples of modules configured to interface with the Phoenix software platform include, but are not limited to, those directed to pre-clinical efforts, safety, stability/quality control, and IV/IVC.

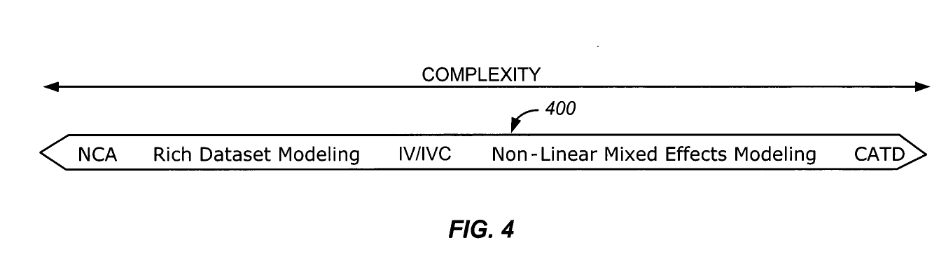

Moreover, FIG. 4 shows the spectrum 400 of the relative complexity of PK-PD techniques and modeling that are typically employed. These PK-PD techniques range from relatively simple non-compartmental analysis (NCA), to highly complex computer-assisted trial design (CATD). Use of the Phoenix drug development platform would provide a single user interface to implement all of these PK-PD approaches.

Use of the Phoenix drug development platform would also provide an integrated, visual environment. Such an integrated visual environment could shortens the learning curve for new or junior staff, helping them transition to more advanced skills, and making the benefits of modeling accessible to more staff.

Use of an integrated drug development platform in accordance with embodiments with the present invention may also allow for technical controls supporting compliance with 21 CFR § 11, which in particular governs electronic records and electronic signatures. This ensures that changes to data can only be made by authorized individuals, who have to “sign” the document with an (the electronic signature). This helps to ensure that an audit trail captures all changes made, allowing rapid identification of who made the changes, when the changes were made, and why the changes were made.

Other possible advantages of an embodiment of an integrated drug development platform in accordance with embodiments of the present invention include large gains in efficiency. For example, scientists currently employ some combination of SAS, NONMEM and S-Plus. That is because NONMEM can perform the modeling, but not the data preparation that is needed to create an analysis file. NONMEM also does not produce report ready tables and figures. Software programs from SAS and S-Plus are usually used with NONMEM to address these deficiencies. However, this requires scientists to learn multiple programs with multiple user interfaces, data formats, etc.

By contrast, according to embodiments of the present invention, data management, data modeling, and data reporting functions are handled utilizing a single platform. This lessens the learning curve and enables projects to be completed in a more efficient manner.

The Design of the Phoenix platform architecture will also support physiologically based pharmacokinetics/pharmacodynamics PB-PK-PD. Anticipated features, and complex modeling and simulation capabilities of the Phoenix platform, include an integrated user experience, and, as explained more fully below, a graphical model building tool, for example the Drug Model Editor (DME) available from Pharsight Corp.

The Phoenix drug development platform features a modeling and simulation language for expert users, and is fully integrated with PKS. Embodiments of the Phoenix platform feature unified scripting language for automation, in-vitro/in-vivo correlation (IV/IVC) functionality, trial simulation, and PB/PK functionality.

As also described in more detail below, the Phoenix platform features plug-in architecture for readily integrating the functionality of drug development, data manipulation, reporting, graphics, modeling, and statistical software applications created by third parties. A consistent mapping interface permits the user to specify how input data will be understood by each analytic plug-in.

The model language of the Phoenix platform is rich in modern programming features, such as domain specific features supporting the definition and statistical analysis of complex mathematical models. The model language of the Phoenix platform supports the standard built-in models such as 1, 2, 3-compartment models, etc. The model language may be compiled to enhance speed of execution. The model language may include provisions for integrating with custom software code created by a user.

Moreover, the user-defined models of the Phoenix platform are fast and powerful. Closed form and differential equation models can be expressed in the Phoenix language. User-defined models are automatically translated and compiled to a C subroutine for speed.

The Phoenix model language also includes special constructs for complicated modeling situations. For example, the Phoenix model language allows the creation of the following model types: time-to-event (hazard) models; time-based (reflux) models; count models (Bernoulli and binomial response); categorical (multinomial) models; 3 hierarchical level models (similar to NONMEM). The Phoenix model language also readily accommodates the following variations typically found in more complex models: multiple dose routes; multiple responses; and support for modeling data collected at steady-state. The Phoenix model language also provides support for automated and manual covariate selection and modeling.

The Phoenix model language promotes a flexible, efficient programming style. For example, it allows arbitrary naming for fixed, random effect, and error parameters, and facilitates construction of diagonal, block diagonal or full random effect covariance matrix structures.

The Phoenix model language also allows at least two styles of error models. These error models include NONMEM-style models having explicit epsilons, and S+ NLME style error models having built-in variance functions.

The Phoenix model language also includes built-in link functions such as logit, probit, etc., and the automatic use of matrix exponents.

The Phoenix platform also includes several state-of-the-art computational engines, and a powerful data visualization engine. The Phoenix platform may also include enhanced WinNonlin computational engines, accommodating, for example, NCA, a modeling engine for rich datasets, and a linear mixed effects engine for Analysis of Variance (ANOVA), Analysis of Co-Variance (ANCOVA), bioequivalence (BE) assessment, and aiding NLME covariate selection.

Other modern computational engines included by Phoenix may comprise one or more of the following: first order (FO), first order conditional expectation (FOCE), Laplacian, and Adaptive Gaussian Quadrature engines for continuous response (Gaussian-based residual errors) models, Laplacian and Adaptive Gaussian Quadrature engines for user-defined log likelihood models, a nonparametric engine for both Gaussian (continuous response) and user-defined likelihood models. Other modern computational engines supported by embodiments of the instant software platform include expectation maximization (EM), naive-pooled engines, and two-stage engines for both Gaussian (continuous response) and user-defined likelihood models—can also be used to initiate other engines. The EM engine can be extended to a Monte Carlo parametric expectation maximization (MCPEM) or SAEM approach. The Phoenix platform also includes diagnostic tools to assist in model building and selection.

The Phoenix platform allows ready integration with software applications directed to common goals in drug development. For example, the Phoenix platform allows clinical trial and drug model simulation engines to be seamlessly integrated with modeling. An IV/IVC modeling engine supported by the Phoenix platform can integrate with convolution and deconvolution engines.

The model language and engines of the Phoenix platform can be run against a growing archive of real world test problems gathered from consulting groups, leading academic researchers, pharmaceutical modeling departments and instructional materials. Performance can be benchmarked and estimates compared against the original NONMEM, S-PLUS NLME or S-ADAPT solutions for each problem. To date, the test problem archive includes problems selected from historical client engagements; problems from university researchers around the globe; problems culled from modeling books, courses & competitions; and problems donated by European and American pharmaceutical modeling departments.

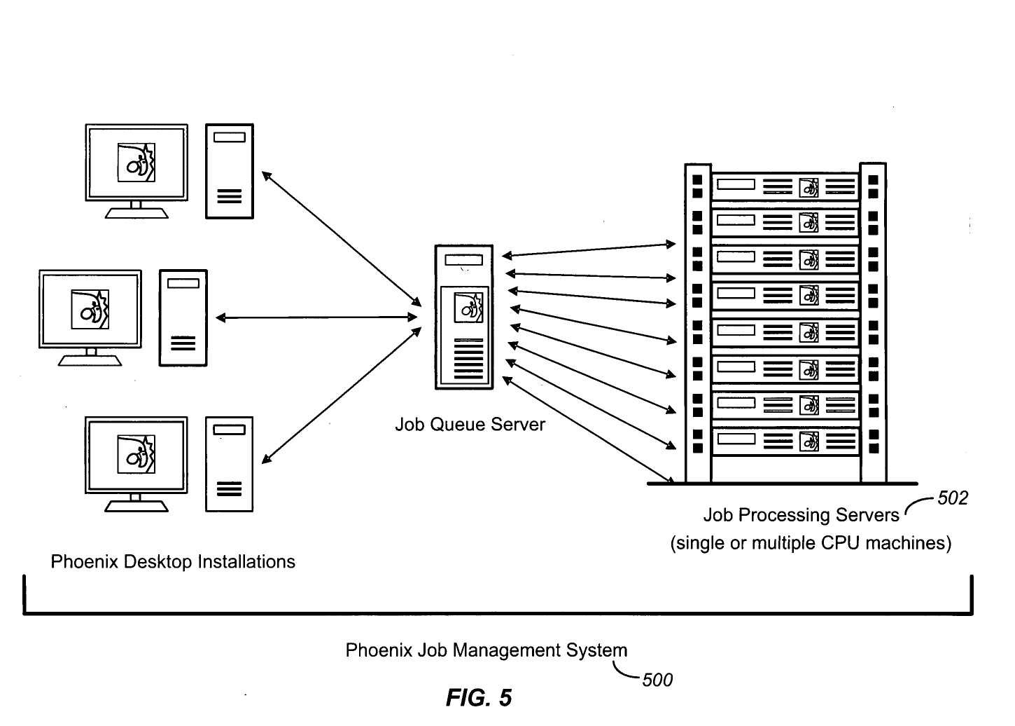

FIG. 5 shows a simplified schematic diagram of architecture of the Phoenix drug development platform job management system 500 in accordance with an embodiment of the present invention. Specifically, FIG. 5 illustrates that Phoenix window services installed on server computers 502 communicate with each other and with desktop installations 504 to provide distributed job processing.

Additional NLME modeling capabilities of the Phoenix platform include built-in support for covariate selection. Such support includes model comparison tools such as AIC and BIC, exhaustive search with grid execution of individual cases; and interface to S-Plus for additional statistical analysis. Other NLME modeling capabilities provided by the Phoenix platform include built-in support for bootstrapping and profile likelihood computation, using grid computation.

The Phoenix platform also includes various state-of-the-art graphics capabilities. The Phoenix platform provides high quality presentation output in the form of multi-figure, multi-sheet displays, lattice plots, and customizable styles for line weight, colors, fonts, etc. Examples of graphical representations of model results or other data supported by the Phoenix platform include overlays of model-predicted results with empirical data, statistical distributions of estimated parameters (e.g. box and whisker plots or histograms), Quantile-Quantile plots of estimated parameters (e.g. normal probability plots), and plots arranged in a lattice-like viewing or printing pane (e.g. two-factor plot matrices, where the axes of the matrix correspond to levels of their respective factors).

The Phoenix platform also provides powerful graphical analytics, including direct, active links between data in plots and data in grids, re-usable graphical diagnostic report templates for different analytic workflows, and data visualization interfaces for computational engines. Such data visualization interfaces allow initial estimation of NLME model parameters through real-time manipulation of prediction curve overlaid on observed data, and graphical selection of lambda-Z boundaries for NCA.

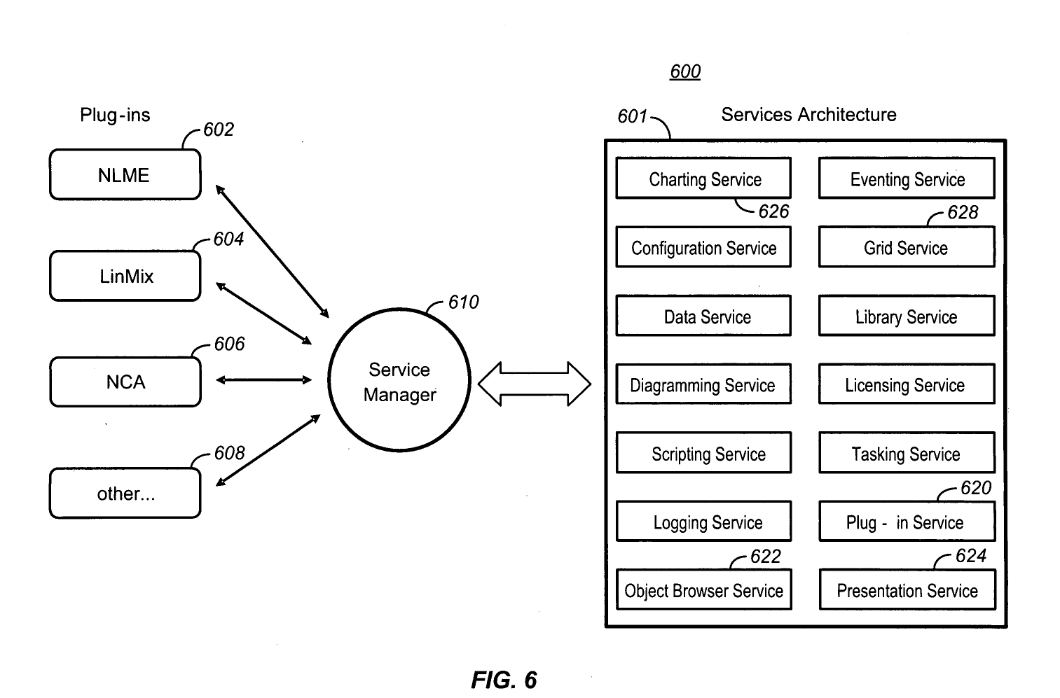

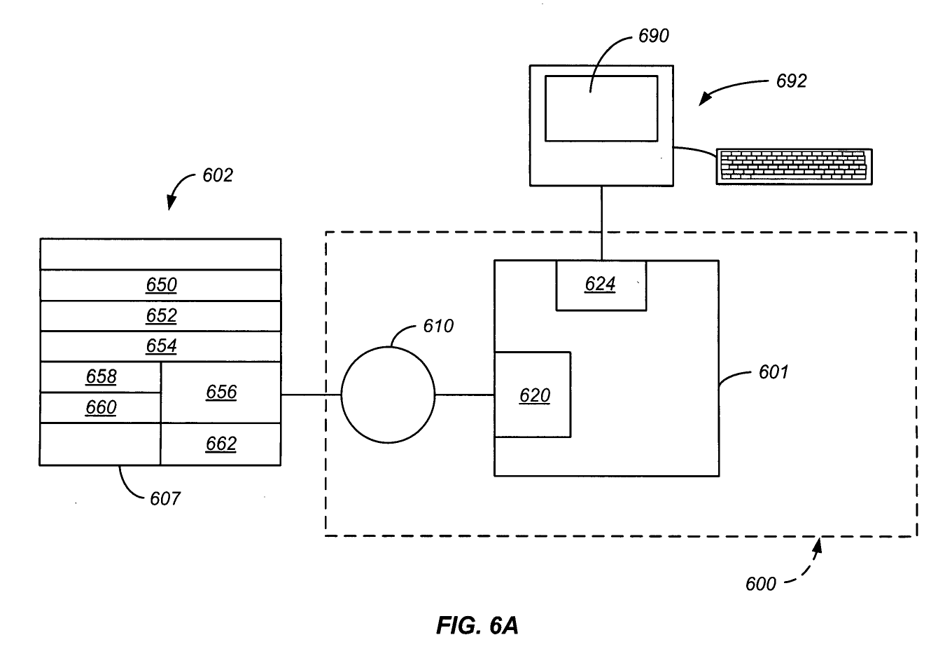

One potentially valuable aspect of the drug development software platforms according to embodiments of the present invention, is compatible and readily interoperable with various plug-in modules to provide specialized functionality. FIG. 6 is a simplified schematic diagram showing interaction between the Phoenix software platform 600 comprising service management layer 610 and services architecture 600, and various plug-in modules such as NLME 602, LinMix 604, NCA 606, and others 608.

Such plug-ins may provide data analysis, data manipulation, simulation, modeling, graphics, or reporting capabilities. The Phoenix platform framework is also expected to provide services to the plug-ins. Examples of services provided by the Phoenix drug development software platform include, but are not limited to, charting services 626, configuration services, data services, diagramming services, scripting services, logging services, object browser services 622, eventing services, grid services, library services, licensing services, tasking services, plug-in services 620, and presentation services 624. Other functionality, including data management, will be provided by Phoenix services.

For example, FIG. 6A shows a simplified schematic diagram illustrating interaction between non-linear mixed effects (NLME) modeling plug-in 602 and the Phoenix software platform 600. Plug-in 602 includes a computer readable storage medium having stored therein code 650 configured to depict a mathematical model as a graphical representation, and code 652 configured to edit the mathematical model utilizing the graphical representation. Code 654 is configured to apply the mathematical model to a data set to produce a result. Code 656 is configured to serve as an interface to communicate the graphical representation and the result through service management layer 610 to plug-in service 620 offered by services architecture 601 of the Phoenix platform. Presentation services element 624 of the services architecture 601 is responsible for displaying the graphical representation of the model to a user through display 690 of computer 692. The computer-readable storage medium responsible for storing the NLME plug-in may further include code 660 configured to communicate model language text to the services architecture for display and change by the user, and code 662 configured to communicate to the services architecture, a progress of application of the model to the data set. Results of the modeling may be presented to the user utilizing the charting service or the grid service.

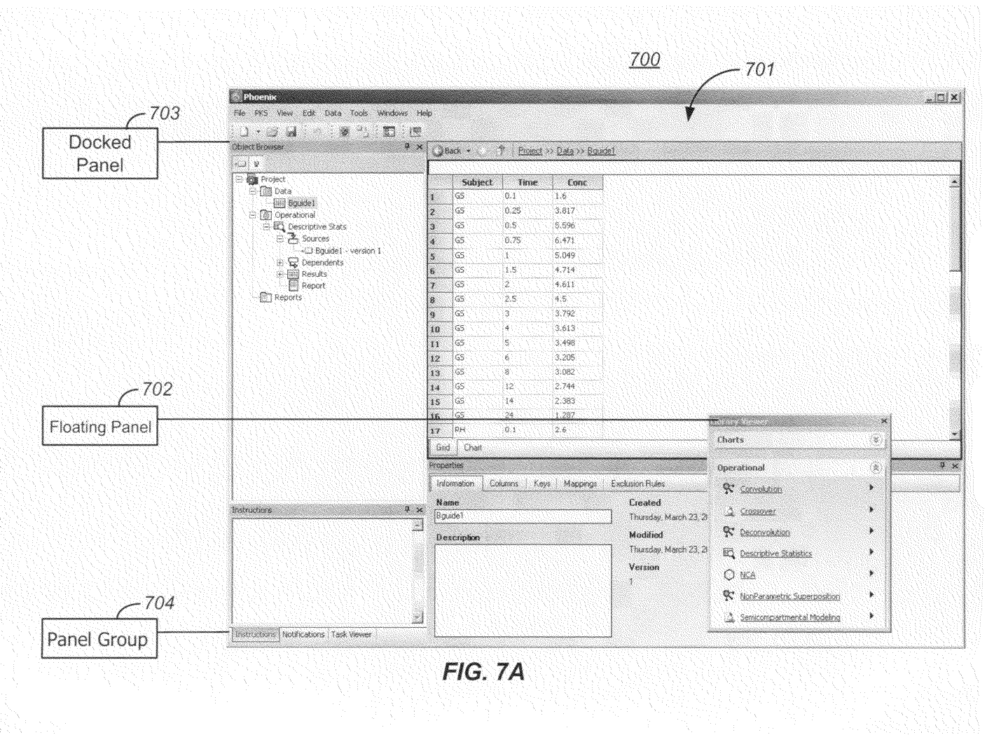

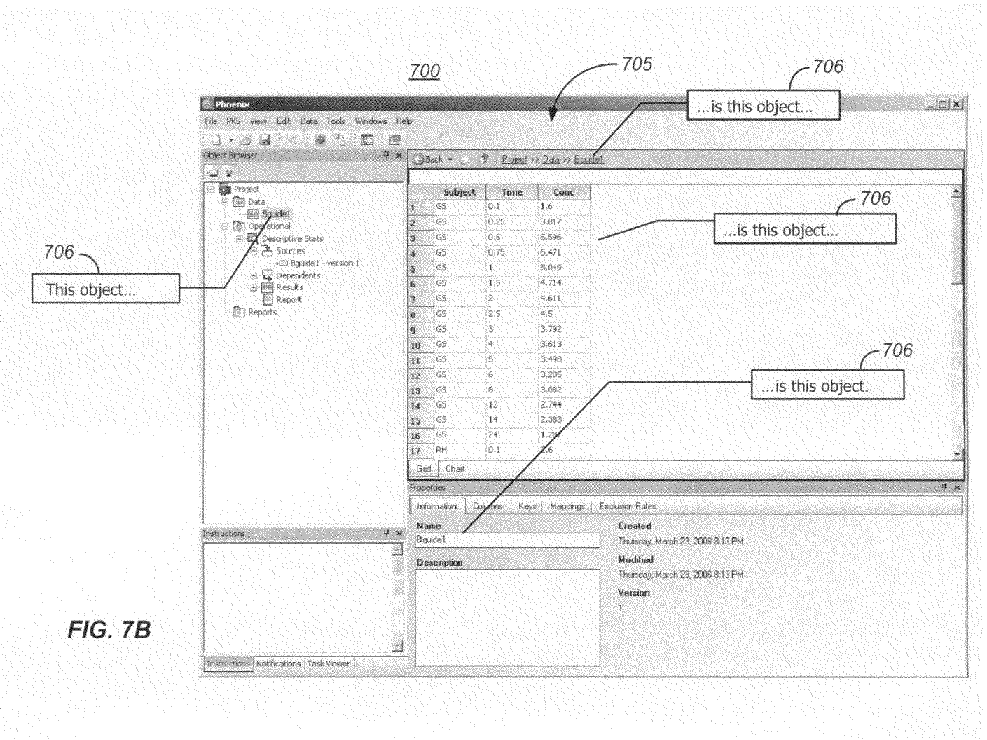

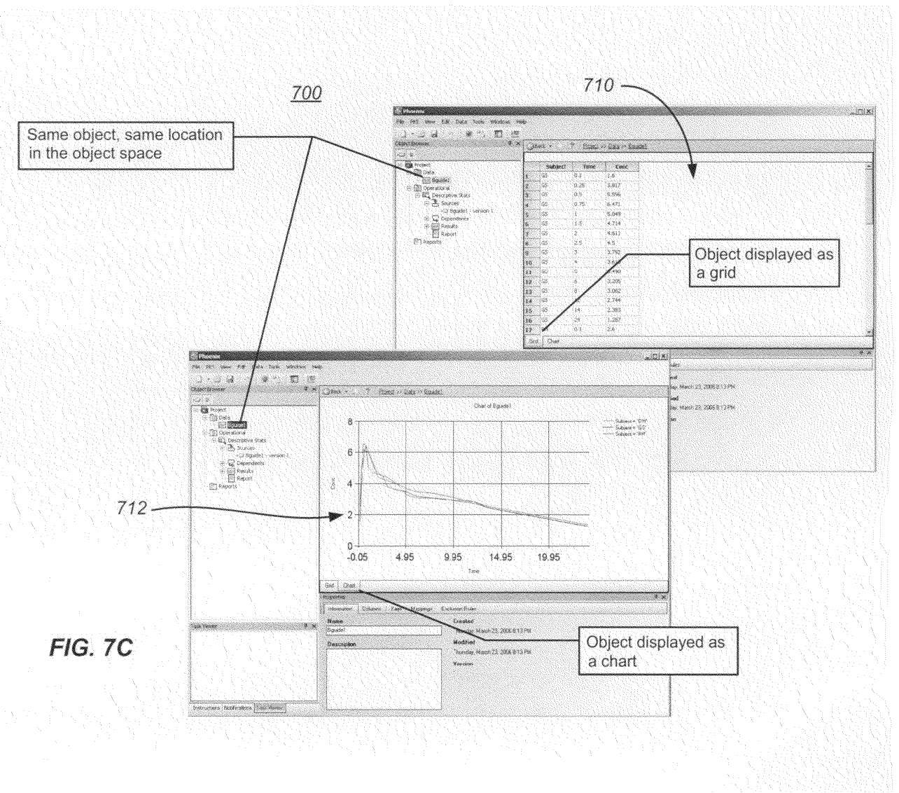

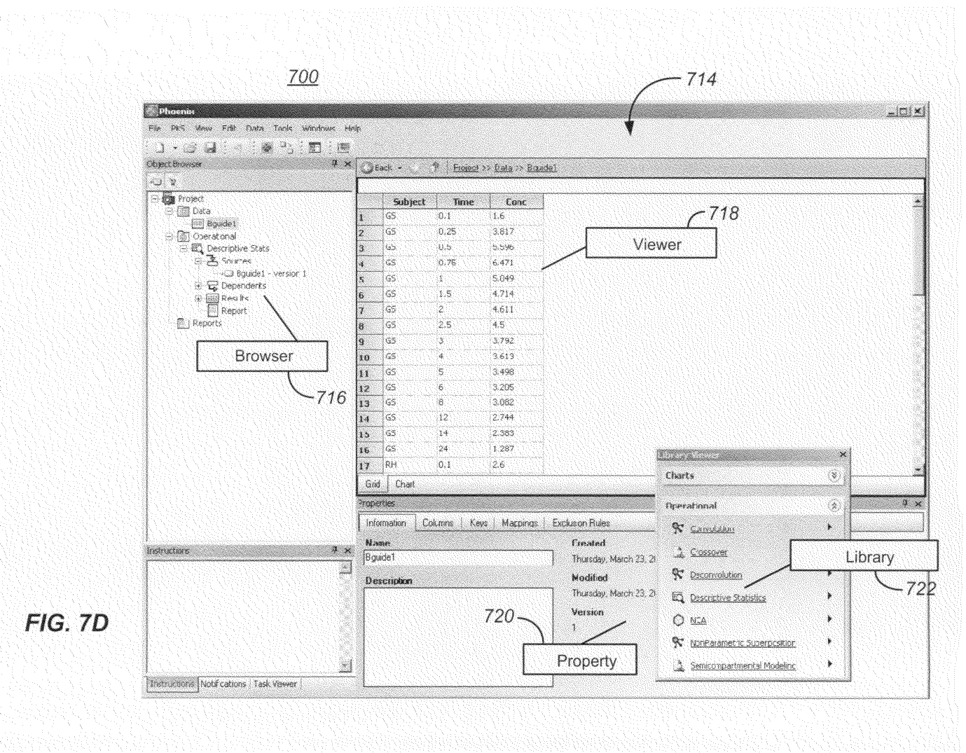

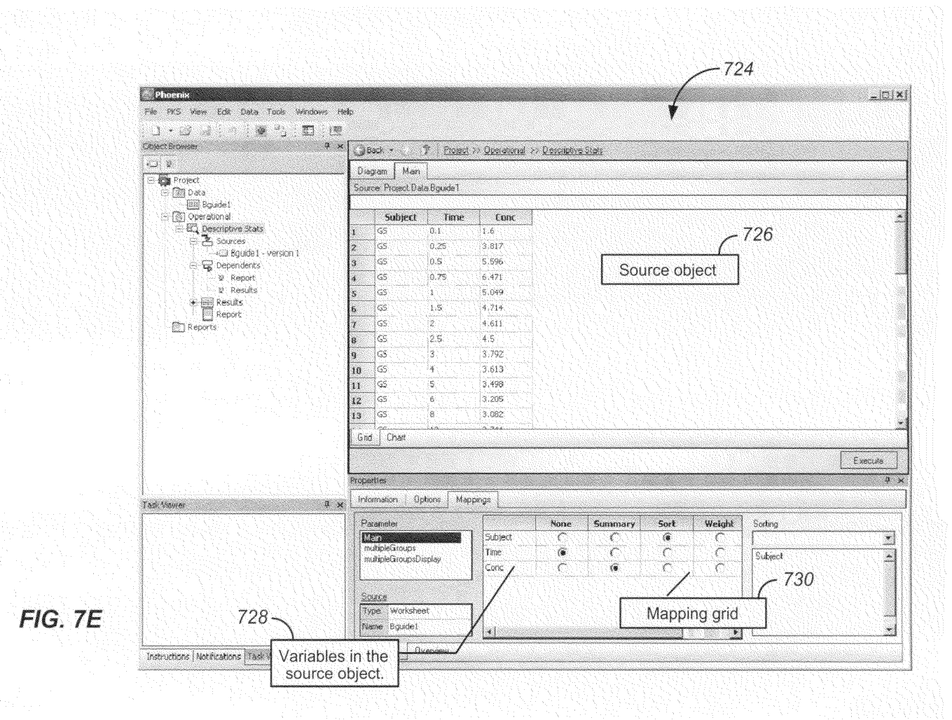

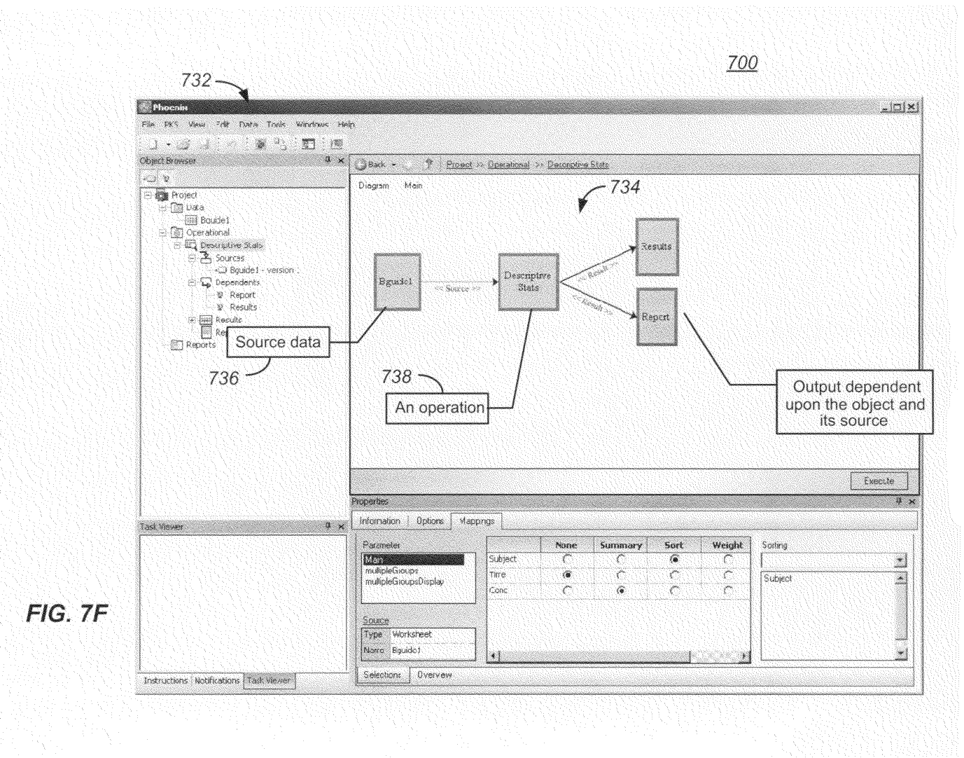

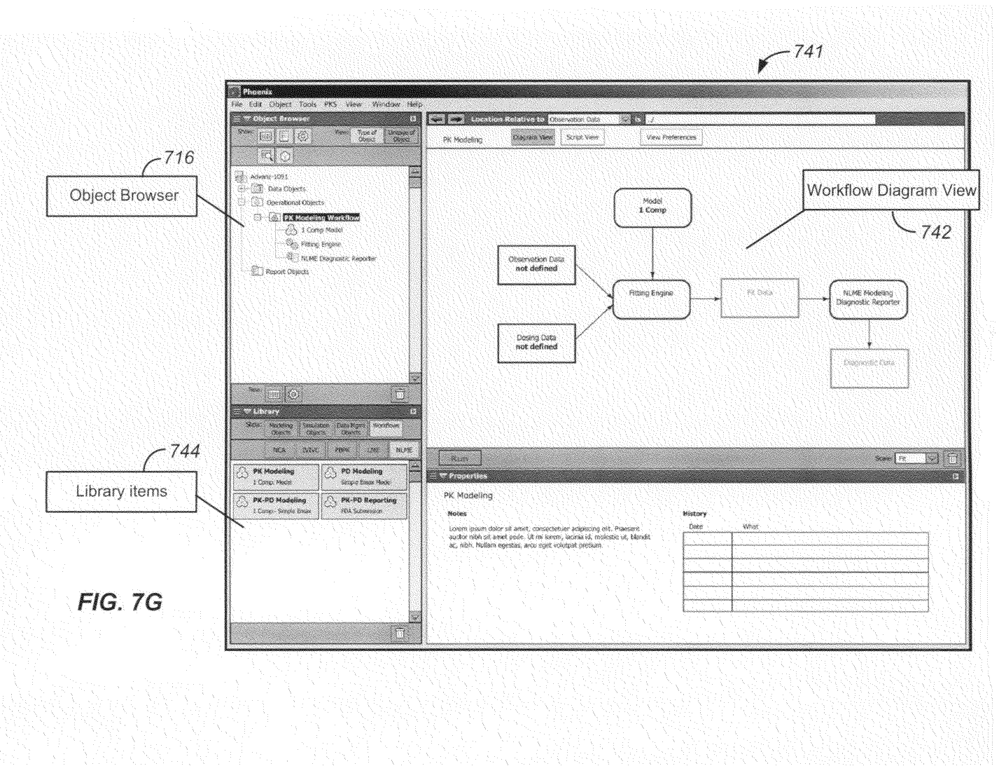

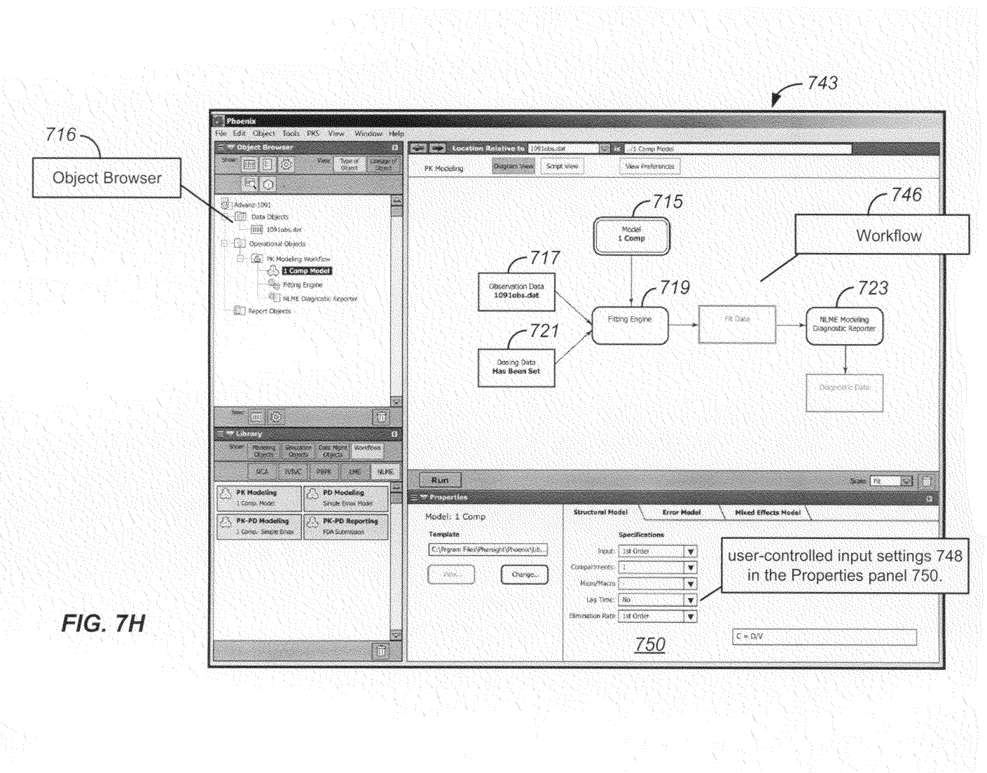

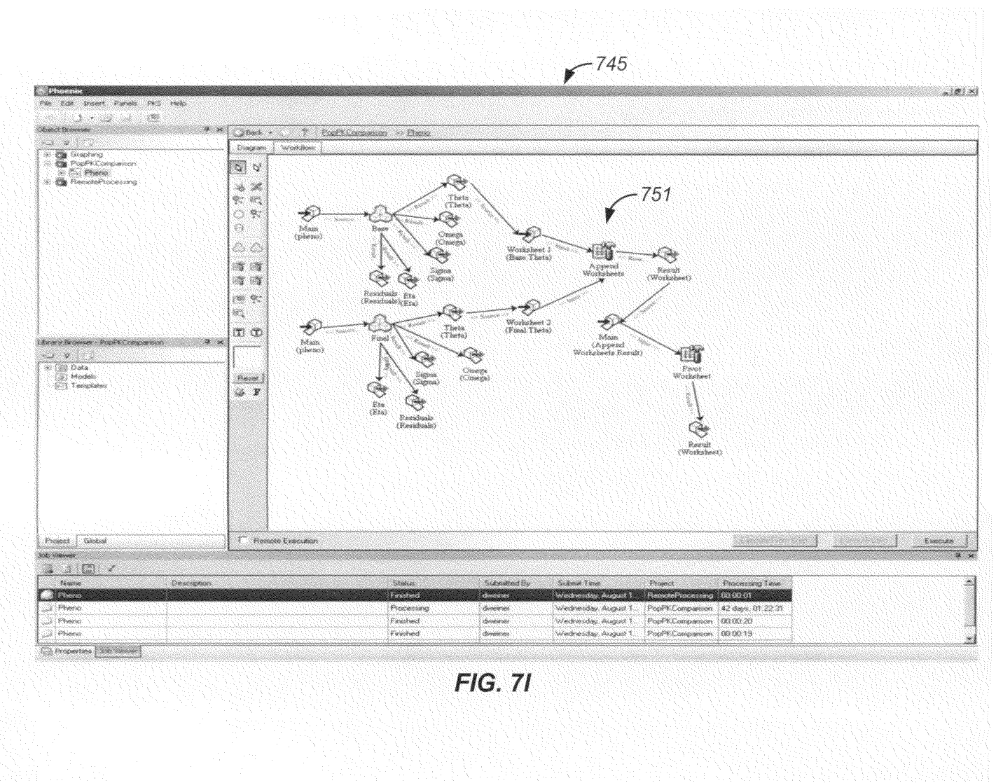

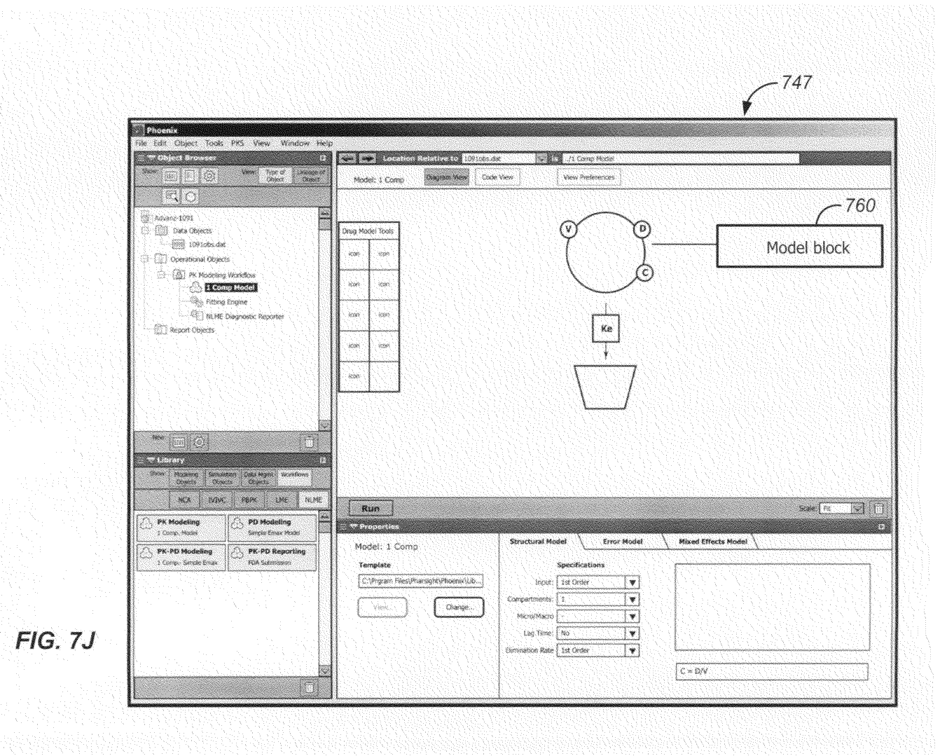

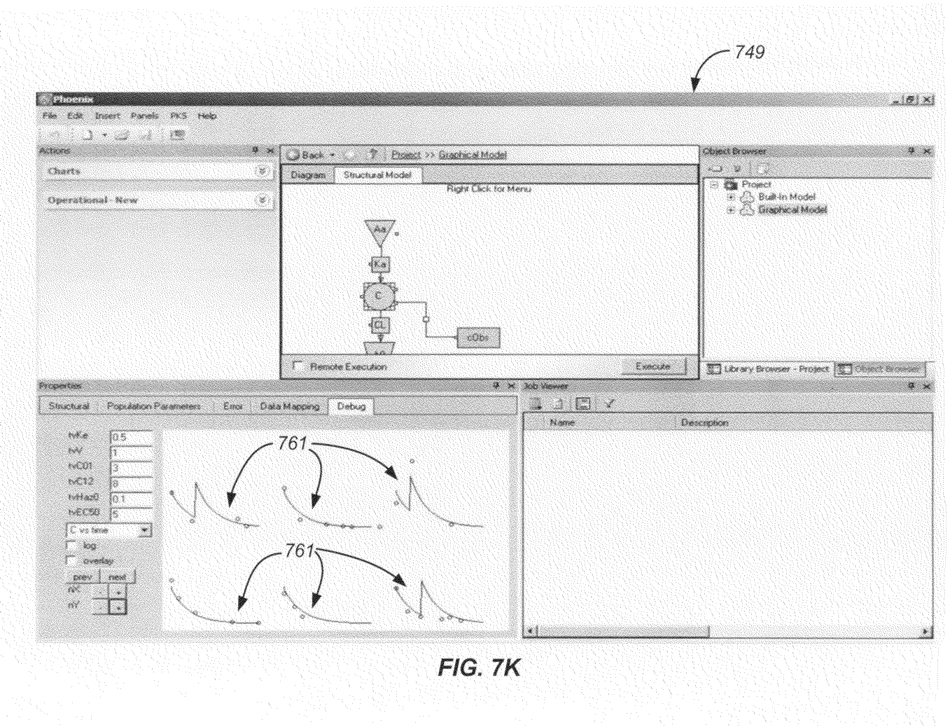

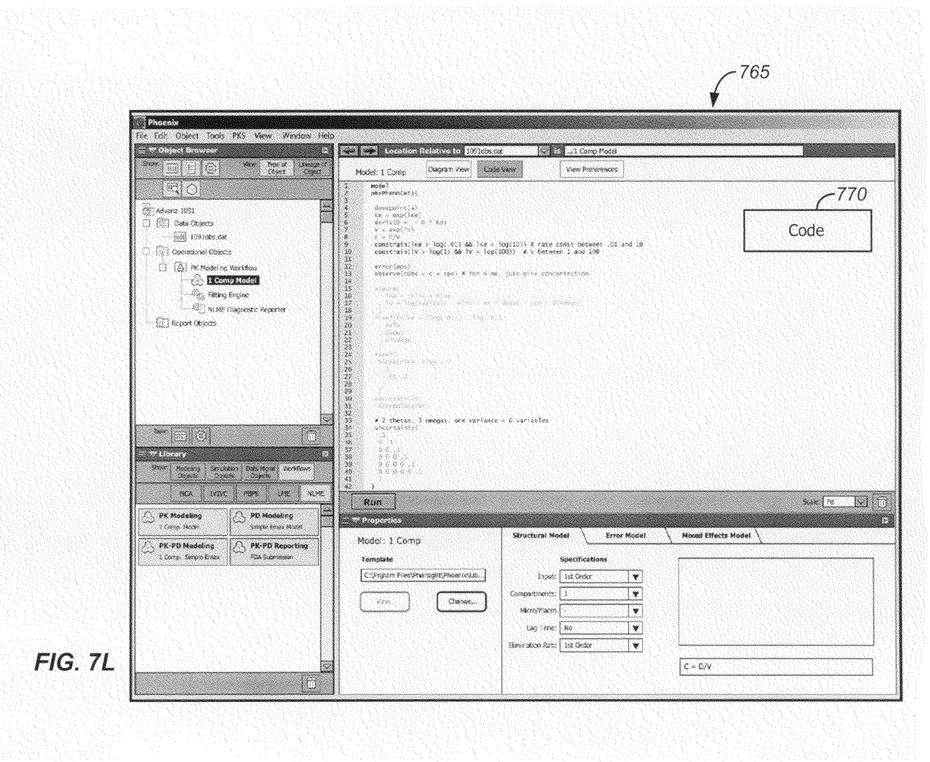

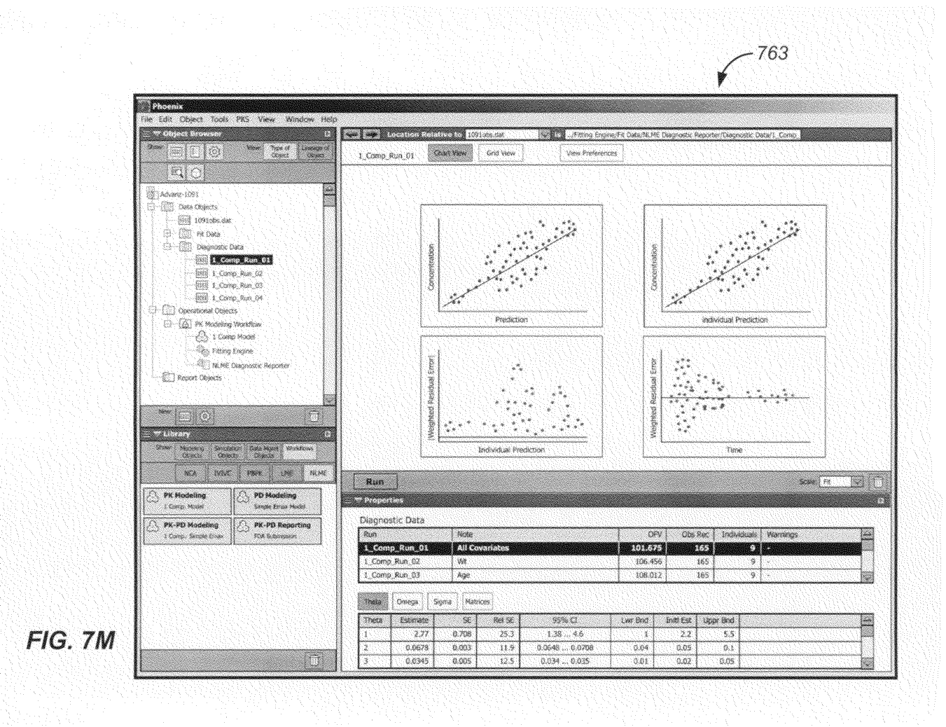

FIGS. 7A-M show screenshots of different elements of a graphic user interface (GUI) of an embodiment of the Phoenix drug development software platform in accordance with the present invention. Specifically, the screenshot 701 of FIG. 7A illustrates a modular graphical user interface 700. Related functionality is grouped into panels 702 that can be docked 703 and arranged in groups 704 by users to fit their individual preferences.

The screenshot 705 of FIG. 7B illustrates the consistent information architecture of the Phoenix platform. In particular, the Phoenix platform is based upon objects 706 that are expected to keep the panels synchronized with respect to this consistent information architecture, making it simple for the user to orient and navigate within the object space. Objects form a basic element of larger workflows that involve the flow of information to and from these objects. Examples of types of objects include, but are not limited to models, tables, graphs, other workflows, data reporting functionalities, and data modifying functionalities such as data filters, data joins, data merges, and the appending of data.

Certain objects may serve to dictate basic threshold parameters of operations that are to be performed by other objects in a workflow. For example, an object could include a reference to a database containing parameters for a particular type of subject (i.e. human, rat, dog etc.) Examples of such parameters include but are not limited to metabolism and body mass.

The screenshots 710 and 712 of FIG. 7C illustrate the displays of data in different ways. Screenshot 710 displays the object as a grid. Screenshot 712 displays the object as a chart. The Phoenix platform maintains consistent reference in the object space no matter how the object is viewed.

The screenshot 714 of FIG. 7D illustrates that panels combine to describe objects. The Phoenix platform provides different panels for visualizing the various aspects of an object. Each panel is specialized, but in sum the panels provide a complete view. For example, as shown in FIG. 7D, the browser 716 indicates where objects are located in the object space of the Phoenix platform. The viewer 718 shows what the object looks like inside. The property panel 720 reveals details about the object, and how the object is configured. The library 722 shows the types of analysis that can be applied.

The screenshot 724 of FIG. 7E illustrates the easy mapping allowed between columns and concepts. A consistent mapping interface permits the user to specify how input data will be understood by each analytic plug-in. FIG. 7E shows source object 726, viewed as an input of the Descriptive Statistics plug-in. FIG. 7E also shows variables 728 in the source object. Mapping grid 730 can be used to tell the Phoenix platform how to map the source variables to the concepts that are used by the plug-in.

The Phoenix platform understands graphical instructions for building operation sequences. The screenshot 732 of FIG. 7F illustrates an operation sequence 734. Source data 736 is subjected to an operation 738 to produce output dependent upon the object and its source.

Sequences of operations, or “Workflows”, may be saved as templates to be re-run later against new sources. Both simple and complex workflows can be saved in the user's library as templates. A saved template can be inserted into a project and mapped to a new source. When run, the template will execute all of the stored steps automatically, or only execute those steps that need updating or refreshing.

The screenshot 741 of FIG. 7G illustrates the powerful, intuitive object visualizations facilitated by the Phoenix platform. Data and operational objects in the Phoenix environment are visualized in ways beyond the conventional grids, tables, and plots. For example, the Object Browser 716 displays objects by type and lineage, the Workflow Diagram View 742 displays the objects in the workflow. The Library items 744 represent complete, stored workflows that can be selected for re-use.

One particularly useful aspect of certain embodiments of drug discovery platforms in accordance with the present invention is in the display of workflow diagrams. The screenshot 743 of FIG. 7H illustrates one example of a simple workflow 746.

Specifically, the workflow 746 includes objects 715, 717, 719, 721 and 723, connected by arrows indicating the direction of flow of information between these objects. For example, fitting engine object 719 receives information from the model 715, the object 717 instructing access to observation data (stored at “1091obs.dat”), and the object instructing access to dosing data 721 that has already been sent to the workflow. The resulting information (the fit data) is communicated to reporter object 723, which in turn communicates the diagnostic data.

Workflow diagrams such as that shown n FIG. 7H can serve to orient the user, providing an overview of the tasks to be completed, as well as a mechanism for navigating to the input settings for each task. As shown in FIG. 7H, selecting the model 715 in the Object Browser 716 or in the Workflow Diagram 746 brings up the user-controlled input settings 748 in the Properties panel 750.

The screenshot 745 of FIG. 7I illustrates a more complex workflow 751 displayed in accordance with an embodiment of the present invention. The workflow depicted in FIG. 7I fits two different modes (“Base” and “Final”) to a dataset (Main), and then generates respective display objects (“Worksheet 1” and “Worksheet 2”). The workflow then combines these display objects to form yet another object of a subset of results (“Append Worksheets”) into a single file/view.

According to various embodiments of the present invention, users can click on any workflow component to view its properties. Moreover, workflows, or parts thereof, can be created, saved, and edited, and copied, pasted, etc. into other workflows. Workflows may be saved independent of the underlying data on which they operate. Thus, a workflow can be saved, and then independently applied to different data sets.

Workflow execution can be initiated from any place in the workflow by just highlighting that component and clicking on “Execute”. That is, a user can execute all, or only a portion of, any workflow. The status of operations within a workflow can be indicated to the user by visual or other cue types. For example, in one embodiment of the present invention, objects that have successfully completed their operation are colored green, while those that have not yet completed their operation are colored red.

Workflows can readily be repeated or refreshed by a user. For example, the change of certain data input to one or more objects may render prior operations not accurate. Embodiments in accordance with the present invention allow a user to rapidly view those objects whose operation is no longer complete, allowing rapid updating of those objects downstream of the change that need to be refreshed. In other embodiments, one or more objects forming a portion of a workflow can be copied and inserted one or more times into another workflow, thereby allowing the operation or combination of operations to be repeated.

As described above, mathematical models may be represented as objects in workflows in accordance with embodiments of the present invention. Examples of models which may be incorporated as objects include but are not limited to compartmental models, physiological based models, pharmacokinetic models, pharmacodynamic models, pharmacokinetic-pharmacodynamic models, the latter existing as effect compartment models or indirect response (turnover) models. Other models may be of enzyme kinetics, or in-vitro/in-vivo correlation. The models may be closed form, expressed as differential equations, or may be a combination of these approaches.

Another potentially useful aspect of embodiments of drug discovery platforms in accordance with the present invention, is the ability to create and edit models in the form of diagrams. Specifically, by manipulating the user interface, graphical models can be built using icons from a palette or toolbar. Phoenix automatically creates the differential equations corresponding to the graphical model, which can then be simulated to fit to data. In certain embodiments, the user may be able to copy the Phoenix derived model code into a differently text model object and directly edit it further.

As shown in the screenshot 747 of FIG. 7J, the Phoenix drug discovery platform can provide a graphical model creation environment. Double clicking the model block 760 in the Workflow Diagram brings up the Model Editor, allowing editing of models. The use of a graphical interface to depict, create, and edit drug models is further described in the following two patents, both of which are incorporated by reference in their entireties herein for all purposes: U.S. Pat. No. 6,937,257; and U.S. Pat. No. 7,043,415. In accordance with certain embodiments, a model can be created and/or configured from a library of models.

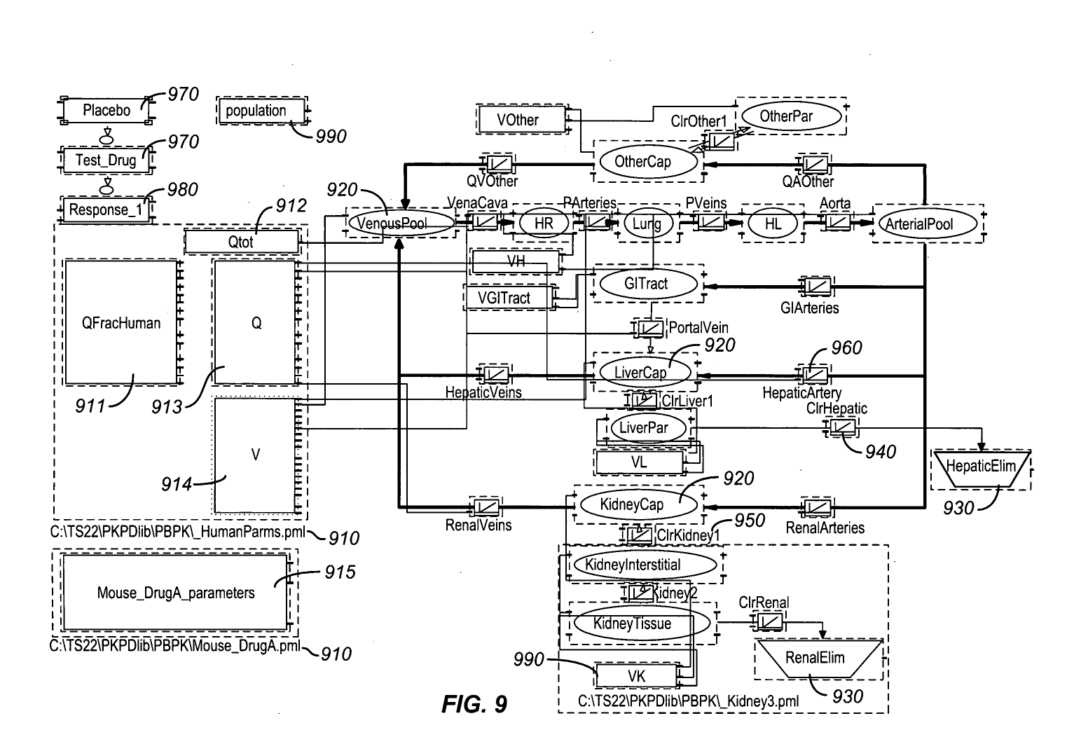

FIG. 9 shows another graphical representation of a different model which can be displayed and manipulated as an object in a workflow according to embodiments of the present invention. In particular, FIG. 9 shows a complex PB-PK model that is capable of being created, displayed, edited, and applied to data utilizing the Phoenix software platform. The embodiment of a physiologically based pharmacokinetic PB-PK model of FIG. 9 has parameters which may be incorporated by reference from library files 910. Connections between tissues 920 in the model are configured as vascular flows 960. The drug can move between compartments via a bi-directional mass flow 950, and can be eliminated 930 by some tissues via a one-directional mass flow 940. Some graphical representation of models according to embodiments of the present invention may also contain formulation blocks 970 and/or equation blocks 980. Blocks 911-915 and 990 set forth the various parameters based upon a human being as a subject.

The screenshot 749 of FIG. 7K shows an example illustrating the use of graphic modeling in conjunction with the data display features according to certain embodiments of the present invention. Specifically, the screenshot of FIG. 7K illustrates the ability to overlay model predicted values with observed data. On the left hand side are shown predicted curves 761 for individual subjects with their observed data overlaid as data points (circles). Utilizing embodiments in accordance with the instant application, will allow visualization of a population view with all subjects data overlaid into a single plot. Users will be able to toggle/modify the parameters in the model (far left), and thereby attempt to get a curve that matches the actual data as much as possible. These parameters could then be used as initial estimates in the model fitting process.

The screenshot 765 of FIG. 7L shows that the graphic user interface of the Phoenix drug development platform in accordance with an embodiment of the present invention, also allows models to be edited as code 770. FIG. 7L shows that the New Model Language is created for coding mixed effects models. The syntax is simple, powerful, and able to address a multitude of modeling conditions. In addition, the Model Editor is expected to be able to be toggled between the graphic view shown in the screenshot of FIG. 7J, and the code editor view of FIG. 7L.

FIG. 7M shows yet another example of a screenshot 763 of an embodiment of a graphic user interface in accordance with an embodiment of the present invention. The screenshot 763 of FIG. 7M illustrates the creation of reports designed for each workflow. Report templates, built-in or user-customized, make it simple to produce standardized displays for evaluating, comparing and presenting analytic output. This functionality obviates the need to save, name, and organize NLME fitting output by hand. Moreover, the Phoenix NLME reporting object automatically support comparison of graphical and tabular data from multiple fitting runs. The user can test any subset of possible covariate effects without having to rebuild the model. This allows the user to evaluate many different covariate effect combinations using a single model build, in parallel, if desired. It should be noted that the particular embodiment shown in the screen shot of FIG. 7M is not comprehensive, as only age and weight are modeled. In accordance with alternative embodiments, other attributes, such as the relationship between the covariates themselves, can be modeled.

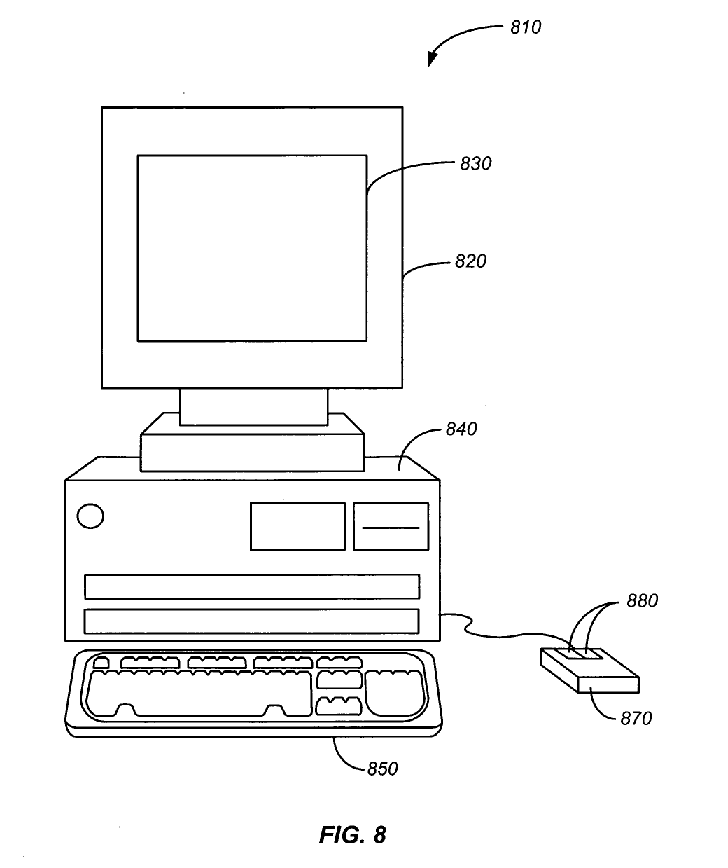

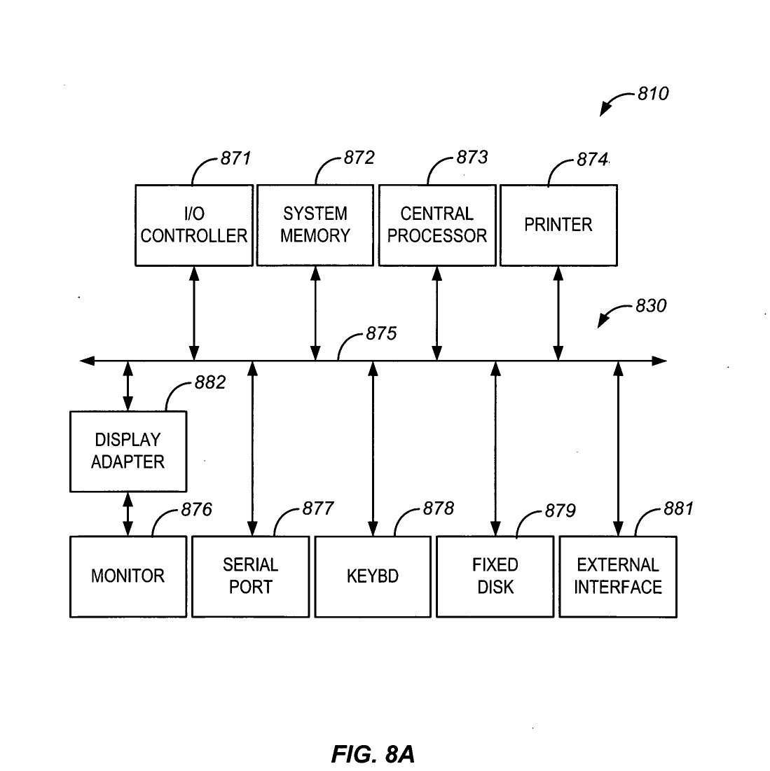

As described in detail above, embodiments of drug discovery methods in accordance with embodiments of the present invention are particularly suited for implementation in conjunction with a computer. FIG. 8 is a simplified diagram of a computing device for processing information according to an embodiment of the present invention. This diagram is merely an example which should not limit the scope of the claims herein. One of ordinary skill in the art would recognize many other variations, modifications, and alternatives. Embodiments according to the present invention can be implemented in a single application program such as a browser, or can be implemented as multiple programs in a distributed computing environment, such as a workstation, personal computer or a remote terminal in a client server relationship.

FIG. 8 shows computer system 810 including display device 820, display screen 830, cabinet 840, keyboard 850, and mouse 870. Mouse 870 and keyboard 850 are representative “user input devices.” Mouse 870 includes buttons 880 for selection of buttons on a graphical user interface device. Other examples of user input devices are a touch screen, light pen, track ball, data glove, microphone, and so forth. FIG. 8 is representative of but one type of system for embodying the present invention. It will be readily apparent to one of ordinary skill in the art that many system types and configurations are suitable for use in conjunction with the present invention. In a preferred embodiment, computer system 810 includes a Pentium™ class based computer, running Windows™ XP operating system by Microsoft Corporation. However, the apparatus is easily adapted to other operating systems and architectures by those of ordinary skill in the art without departing from the scope of the present invention.

As noted, mouse 870 can have one or more buttons such as buttons 880. Cabinet 840 houses familiar computer components such as disk drives, a processor, storage device, etc. Storage devices include, but are not limited to, disk drives, magnetic tape, solid state memory, bubble memory, etc. Cabinet 840 can include additional hardware such as input/output (I/O) interface cards for connecting computer system 810 to external devices external storage, other computers or additional peripherals, further described below.

FIG. 8A is an illustration of basic subsystems in computer system 810 of FIG. 8. This diagram is merely an illustration and should not limit the scope of the claims herein. One of ordinary skill in the art will recognize other variations, modifications, and alternatives. In certain embodiments, the subsystems are interconnected via a system bus 875. Additional subsystems such as a printer 874, keyboard 878, fixed disk 879, monitor 876, which is coupled to display adapter 882, and others are shown. Peripherals and input/output (I/O) devices, which couple to I/O controller 871, can be connected to the computer system by any number of means known in the art, such as serial port 877. For example, serial port 877 can be used to connect the computer system to a modem 881, which in turn connects to a wide area network such as the Internet, a mouse input device, or a scanner. The interconnection via system bus allows central processor 873 to communicate with each subsystem and to control the execution of instructions from system memory 872 or the fixed disk 879, as well as the exchange of information between subsystems. Other arrangements of subsystems and interconnections are readily achievable by those of ordinary skill in the art. System memory, and the fixed disk are examples of tangible media for storage of computer programs, other types of tangible media include floppy disks, removable hard disks, optical storage media such as CD-ROMS and bar codes, and semiconductor memories such as flash memory, read-only-memories (ROM), and battery backed memory.

While the above is a full description of the specific embodiments, various modifications, alternative constructions and equivalents may be used. Therefore, the above description and illustrations should not be taken as limiting the scope of the present invention.

What is claimed is:

1. A system for drug modeling and simulation comprising:
a processor; and
a computer-readable storage medium having code stored thereon configured to instruct a processor to,
display a graphical workflow comprising an object and a flow of information to and from the object,
apply the workflow to a data set;
display a progress of completion of the operation by the workflow, and
update the workflow to reflect a changed attribute of the object or an application of the workflow to a different data set.

2. The system of claim 1 wherein the object comprises a mathematical model, the computer-readable storage medium further comprising code stored thereon configured to instruct a processor to,
display a graphical representation of the model, and
allow a user to edit the structure of the model utilizing the graphical representation.

3. The system of claim 2 wherein the code stored on the computer-readable storage medium further comprises instructions to the processor to display the model language code comprising the model.

4. The system of claim 1 wherein the object is selected from a model, a data filter, a data join, a data merge, a data append, another workflow, a direction to access a data set, or a direction to access a set of basic parameters.

5. The system of claim 1 wherein the code stored on the computer-readable storage medium further comprises instructions to the processor to create a graphical representation of a result of operation of the object or other data.

6. The system of claim 5 wherein the graphical representations of the results are selected from an overlay of results predicted from the model with empirical data, statistical distributions of estimated parameters, Quantile-Quantile plots of estimated parameters, or plots arranged in a lattice-like viewing or printing pane.

7. The system of claim 1 wherein the code stored on the computer-readable storage medium further comprises instructions to the processor to display the object as a chart or as a table.

8. A method comprising:
causing a display of a graphical workflow to a user, the workflow comprising an object and a flow of information to and from the object;
causing a display of a result of application of the workflow to a data set;
allowing the user to change an attribute of the object or the data set, utilizing the graphical workflow;
updating the display of the workflow to reflect the changed attribute or the changed data set.

9. The method of claim 8 comprising:
changing a color of the display to indicate a progress of completion of the workflow.

10. The method of claim 8 comprising:
copying a portion of the workflow; and
allowing the user to insert the portion into a second workflow utilizing a graphical display of the second workflow.

11. The method of claim 8 wherein the object comprises a mathematical model, the method further comprising displaying a structure of the mathematical model in graphical form.

12. The method of claim 11 further comprising allowing the user to modify the model structure utilizing the graphical display.

13. The method of claim 8 further comprising:
storing the workflow as a template; and
creating a second graphical workflow by accessing the stored workflow template.

14. A system to perform modeling and simulation of data for drug development, the system comprising:
a services architecture configured to display a workflow comprising a plurality of objects connected by lines to depict a flow of information between the objects, the services architecture further configured to communicate with a plug-in through a service management layer, the plug-in providing a functionality selected from data manipulation, modeling, graphics creation, report generation, data analysis, and third party tool integration.

15. The system of claim 14 wherein the services architecture is hosted on a first job processing server, the plug-in is hosted on a second job processing server, and the service management layer comprises a job queue server in electronic communication with the first job processing server and the second job processing server.

16. The system of claim 14 wherein the services architecture is configured to provide a service selected from a charting service, a configuration service, a data service, a diagramming service, a scripting service, a logging service, an object browser service, an eventing service, a grid service, a library service, a licensing service, a tasking service, a plug-in service, and a presentation service.

17. The system of claim 14 further comprising creating a persistent link between the services architecture and the plug in.

18. A computer software plug-in program comprising a computer-readable storage medium having stored thereon code configured to instruct a processor to,
depict a mathematical model as a graphical representation;
edit the mathematical model utilizing the graphical representation;
apply the mathematical model to a data set to produce a result; and
serve as an interface to communicate the graphical representation and the result through a service management layer to a services architecture responsible for displaying the graphical representation and the result to a user.

19. The computer software plug-in program of claim 18 wherein the code is further configured to communicate source code comprising the model to the services architecture for display to the user.

20. The computer software plug-in program of claim 18 wherein the code configured to depict and editing the mathematical model, is further configured to maintain a persistent link to the model as an object in a workflow displayed to the user by the services architecture.

21. The computer software plug-in program of claim 20 further comprising code for communicating to the services architecture, a progress of application of the model to the data set.
